(19) United States
(12) Patent Application Publication
(10) Pub. No.: US 2008/0030485 A1
(43) Pub. Date: Feb. 7, 2008

(54) Surface wave type touch panel

(75) Inventors: Michiko Endo, Shinagawa (JP); Takashi Nakajima, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 11/713,051

(22) Filed: Mar. 2, 2007

(30) Foreign Application Priority Data
Aug. 2, 2006 (JP) 2006-211182

(51) Int. Cl. G06F 3/043

(52) U.S. Cl. 345/177

(57) ABSTRACT

The present invention is directed to the provision of a touch panel comprising a glass plate, a film that faces a surface of the glass plate, and dot spacers formed on the glass surface that faces the film, wherein the effective diameter of the dot spacer portion 51 that contacts the glass substrate is held within one half of the wavelength of a surface propagating acoustic wave. This arrangement serves to enhance the efficiency of surface acoustic wave propagation in the touch panel.

### FIELD OF THE INVENTION

The present invention relates to a surface acoustic wave type touch panel, and more particularly to dot spacers in the touch panel.

### BACKGROUND OF THE INVENTION

Many types of touch panels are known, such as the resistive film type (analog resistive film type), ultrasonic surface acoustic wave type, infrared interruption type, capacitive type, electromagnetic induction type, and image recognition type. Among these types, the present invention employs the ultrasonic surface acoustic wave (hereinafter also referred to as SAW (Surface Acoustic Wave)) type.

Touch panels of the SAW type make use of surface acoustic waves that are also used in SAW filters, etc. Electrodes as transducers for converting electrical signals into mechanical vibrations are provided along the four sides of a panel constructed from a rectangular glass substrate, and high-frequency acoustic wave vibrations (for example, of about 20 MHz) are transmitted out from the transducers on the driving side. Vibrations of such high frequency do not propagate through the glass substrate, but propagate along the surface of the glass. Each transducer is designed with a special structure so that the vibrating wave travels parallel to a diagonal line with respect to the electrode. The vibrations are propagated to the transducers on the detecting side; these transducers, contrary to the transducers on the driving side, convert the mechanical vibrations into electrical signals. In this situation, when a specific position on the panel is touched with a finger, the vibration is absorbed by the finger at that position, and the amplitude level of the received signal is thus attenuated.

Arrays of transducers oriented at right angles to the respective diagonal lines are arranged in parallel to each other along the vertical sides of the rectangular panel, and the vibrations propagate in a predetermined time while resonating. The vibrations are finally transmitted to the detecting transducers. As described above, when the glass surface is touched with a finger, the vibration (energy) at that position is absorbed by the finger. Therefore, the position at which the energy was absorbed is detected based on the ratio of the time required for the transmission. This basic technology known in the art is disclosed in WO 01/90874A1 and Japanese Unexamined Patent Publication No. 2002-222041.

FIG. 8 is a cross-sectional view taken along the center line of a prior known SAW touch panel. In the figure, reference numeral 1 is the touch panel, 2 is a cover film, 3 is a double-sided adhesive tape, 4 is a glass substrate, 5 is a dot spacer, 6 is a chevron-shaped electrode, 7 is a piezoelectric thin film, and 8 is a ground electrode. In the SAW touch panel 1, the chevron-shaped electrodes 6 are formed around the outer edges of the rectangular glass substrate 4, which is covered with the cover film 2. The dot spacers 5 are arranged so as to prevent the cover film from contacting the glass when the film sags due to changes in environmental conditions, etc. Reference numeral 9 represents the surface acoustic wave (SAW) propagating along the glass surface. Since the panel can basically be constructed using a single glass substrate, the SAW touch panel 1 can achieve high transmittance and long life, but when the single glass substrate is used by itself, the glass may break due to impact or the like, scattering broken pieces and thus posing a hazard to humans, and also, moisture may condense on the glass surface causing malfunctions. In order to avoid such problems, a transparent cover film may be placed on the outermost surface.

FIG. 9 is a top plan view of the SAW touch panel. Reference numerals 10 and 10′ designate the transducers on the driving side, and 11 and 11′ the transducers on the detecting side. Reference numeral 12 indicates the direction of SAW propagation. This shows that the SAWs propagate parallel to the respective diagonal lines.

FIG. 10 shows signal waveforms in the panel. The y-axis represents signal magnitude, and the x-axis represents time. Reference numeral 13 indicates the signal applied to the transducer on the driving side, and 14 represents the signal detected by the transducer on the detecting side. Reference numeral 15 shows a signal dropout due to the touching with a finger.

Traditionally, dot spacers have been formed by screen printing. FIG. 11 is a cross-sectional view of dot spacers formed by this technique. In FIG. 11, reference numeral 4 indicates the glass substrate, and 5 the dot spacers. As shown in FIG. 12, each dot spacer 5 is formed in the shape of a mountain having long slopes, and the area of the portion contacting the glass substrate 4 is large, the cross-sectional area gradually decreasing toward the top. Generally, the dot spacers 5 are formed from synthetic resin material, and have the property of absorbing the SAWs propagating along the glass surface, resulting in the attenuation of the SAWs. Accordingly, if a desired dot space height is to be secured, the contact area with the glass substrate 4 will increase, increasing the effect on the SAW propagation and making signal detection difficult.

Japanese Unexamined Patent Publication Nos. H03-238519 and 2004-348686 disclose examples that use dot spacers 100 microns and several tens of microns in diameter, respectively, but neither of these patent documents discusses the relationship between the dot spacer size and the SAW wavelength.

### SUMMARY OF THE INVENTION

The present invention is directed to the provision of dot spacers of the structure, which does not degrade the propagation efficiency of surface acoustic waves.

The touch panel of the present invention comprises a glass plate, a film that faces a surface of the glass plate, and dot spacers formed on the glass surface that faces the film, wherein the dot spacers are each formed not larger in diameter than one half of the wavelength of a surface propagating acoustic wave.

According to a second mode of the present invention, the dot spacers in the touch panel are formed on the glass surface by using a photolithographic process, in order to secure a desired dot spacer height while limiting the contact area with the glass substrate 4.

According to a third mode of the present invention, the dot spacers in the touch panel of the first or second mode of the present invention are each formed in the shape of a polygonal or cylindrical column or in the shape of an overhanging polygonal or cylindrical column.

According to a fourth mode of the present invention, the dot spacers in the touch panel of the first mode of the present invention are formed by dispersing beads, each having a diameter not larger than one half of the wavelength of the surface propagating acoustic wave, or rods, each having a diameter or length not larger than one half of the wavelength, and by bonding the beads or rods to the glass plate.

According to a fifth mode of the present invention, the beads in the touch panel of the fourth mode of the present invention are dispersed at a density not higher than 10 beads per square millimeter.

According to the present invention, since the dot spacer size is held so as not to exceed one half of the wavelength of the surface acoustic wave while also reducing the area of the dot spacer portion contacting the glass substrate, the attenuation of the surface acoustic wave can be suppressed, and compared with the dot spacers formed by screen printing, the propagation efficiency can be greatly improved. Since the panel is constructed using a single glass substrate, the SAW touch panel has high transmittance, is less prone to color variations, provides clear visibility, and does not degrade the display quality of a liquid crystal display apparatus. Substantially the same characteristics can be achieved by using material having high transparency as the cover film.

### BRIEF DESCRIPTION OF THE DRAWINGS

The above object and features of the present invention will be more apparent from the following description of the preferred embodiment with reference to the accompanying drawings, wherein:

FIG. 1 is a diagram showing the relationship between dot spacer size and propagation loss;

FIG. 2 is a table showing the relationship between the diameter of a printed dot spacer, dot size/wavelength, and the propagation loss in relation to the data shown in FIG. 1;

FIG. 3 is a diagram showing the structure of a polarizer to be used instead of a cover film;

FIG. 4 is a cross-sectional view showing dot spacers according to one embodiment of the present invention;

FIG. 5 is a diagram showing a fabrication process for a SAW touch panel according to the present invention;

FIG. 6 is a cross-sectional view showing overhanging dot spacers;

FIG. 7 is a cross-sectional view showing dot spacers using glass beads;

FIG. 8 is a cross-sectional view of a prior art SAW type touch panel;

FIG. 9 is a top plan view of the prior art SAW type touch panel;

FIG. 10 is a signal waveform diagram showing a driving signal and an output signal in the prior art SAW type touch panel; and

FIG. 11 is a cross-sectional view showing dot spacers formed by screen printing according to the prior art.

### DESCRIPTION OF THE PREFERRED EMBODIMENTS

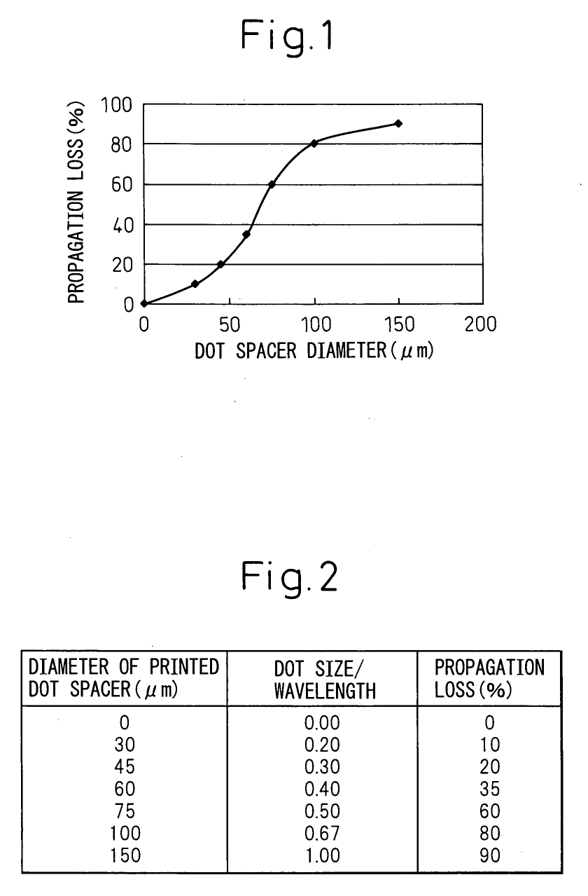

For many years, the present inventors have conducted extensive experiments and studies on the relationship between dot spacer size and the attenuation that surface acoustic waves suffer during transmission. FIG. 1 is a diagram showing one example of the relationship between dot spacer size and propagation loss. In this example, the propagation loss was measured by varying the dot spacer diameter when the propagation frequency was 20 MHz (wavelength of approximately 150 μm) and the dot spacer pitch was 2 mm. The propagation loss (%) is plotted along the y-axis, and the dot spacer diameter (μm) along the x-axis. FIG. 2 shows the measurement conditions, the dot spacer diameter, the ratio of the dot spacer diameter to the surface acoustic wave wavelength, and the resulting propagation loss.

As can be seen from the diagram, according to the above studies, it has been found that the loss rapidly increases when the dot spacer diameter contacting the glass surface (in the case of a circular shape, the diameter in the strict sense of the word, but in the case of a polygonal shape, the diagonal length corresponding to the diameter) exceeds one half of the SAW wavelength. That is, when the dot spacer size is larger than one half of the wavelength of the surface acoustic wave, the amount of attenuation that the surface acoustic wave suffers becomes large, making touch panel detection difficult. It has also been found that the amount of attenuation decreases as the area of the dot spacer contacting the glass surface is reduced. Empirically, when the propagation loss is 50% or less, detection of touch is possible.

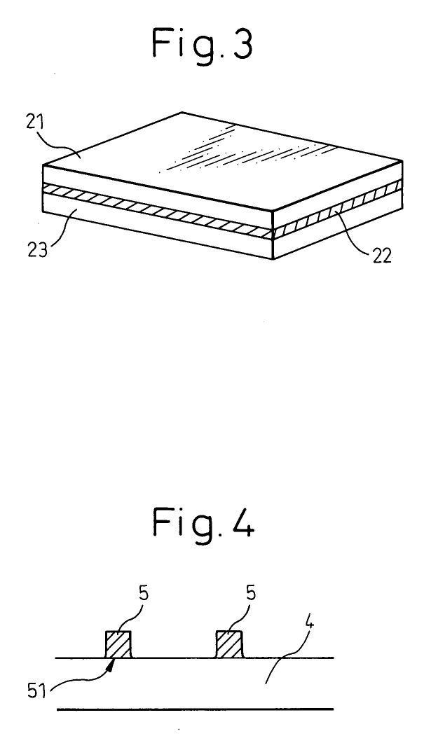

A first embodiment of the present invention concerns an example in which the dot spacers are formed by a photolithographic process. In the prior art touch panel shown in FIG. 8, a transparent plastic film, such as PET, polycarbonate, cycloolefin, or the like, was used as the cover film 2. FIG. 3 shows the structure of a polarizer when the polarizer is used as the cover film. This polarizer has a three-layer structure, in which the first layer 21 is formed from TAC (triacetyl cellulose), the second layer 22 is formed from PVA (polyvinyl alcohol), and the third layer 23 is formed from TAC. Here, the cover film may not be provided.

The driving frequency of the touch panel was set, for example, to 20 MHz, and dot spacers 5 each having a square column shape measuring approximately 35 μm square (with a diagonal length of approximately 50 μm) were fabricated. Since, in this case, the wavelength was approximately 150 μm, the dot spacers 5 were each chosen to have a diagonal length of 50 μm (each side being approximately 35 μm long), which is shorter than the half wavelength of 75 μm. Further, since the amount of attenuation decreases as the area of the dot spacer 5 contacting the glass surface is reduced, as earlier stated, in the present embodiment the square column-shaped dot spacers were formed in place of the mountain-shaped dot spacers of the prior art that tend to degrade the propagation efficiency. To achieve the square column shape, the present inventors formed the dot spacers using a photolithographic process.

In the first embodiment, the dot spacers substantially square in shape with each side approximately 35 μm long as described above, and having a height of 5 μm to 10 μm, were formed using a photosensitive resin material, such as an acrylic, silicone, urethane, or like resin.

When the spacers were formed at a pitch of 1 mm to 3 mm, and a hard-coated PET film having a thickness of 188 μm was used as the cover film, the required actuation force (the load necessary to effect actuation) was optimum and good operability was achieved. Further, it has been found that even when the film sags due to changes in environmental temperature, etc., the film can be prevented from contacting the glass.

FIG. 4 is a cross-sectional view showing the formed spacers. In the figure, reference numeral 4 indicates the glass substrate on which the dot spacers 5 are formed. Each of the dot spacers 5 formed in this way by photolithography and etching has a cross-sectional shape identical to that of a square column (depending on the photolithographic pattern, dot spacers having a substantially cylindrical shape can also be formed). The diameter of the glass contacting portion 51 of each dot spacer 5 is substantially equal to the diameter of the dot spacer 5 itself.

When this dot spacer is compared with a prior art type dot spacer (formed by screen printing) having the same height, it can be seen that, in the case of the dot spacer 5 of the present invention formed by photolithography, the area contacting the glass is smaller than that of the prior art dot spacer. This serves to greatly improve propagation efficiency.

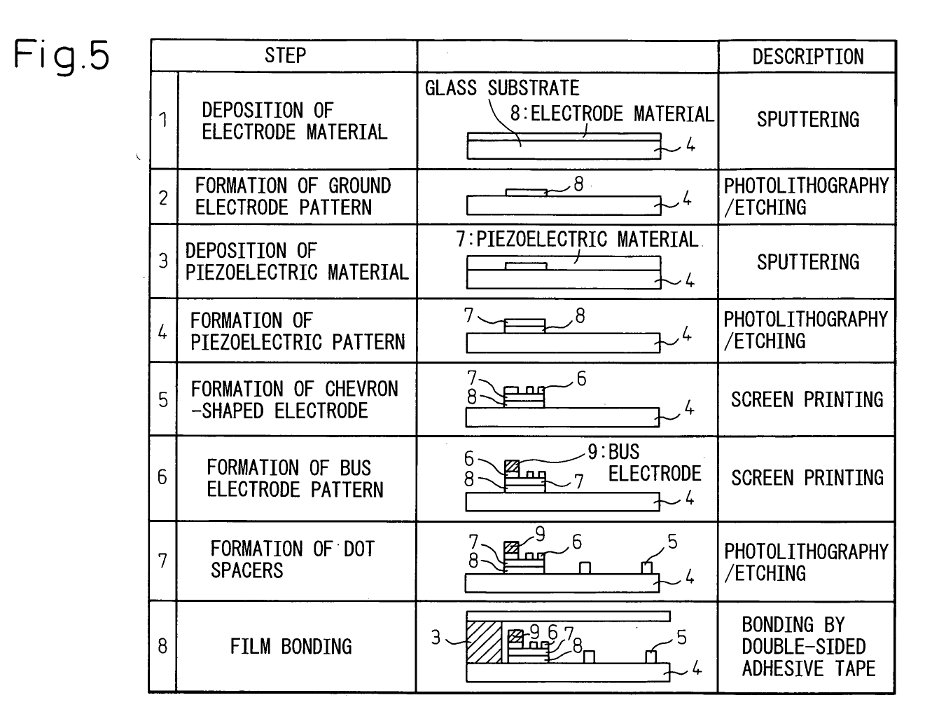

FIG. 5 is a diagram showing a fabrication process, including the above photolithographic process, for the touch panel according to the present invention. The center column of the figure shows the sequence of processing in which the panel is fabricated from the panel substrate, starting with a glass substrate. The left column shows the fabrication steps of the panel, and the right column shows the processing performed in the respective steps.

The first step is the step (step 1) of depositing an electrode material over the entire surface of the glass substrate. The electrode material is deposited in the form of a film by sputtering. In the next step, the thus deposited electrode is patterned into the ground electrode 8 by using photolithographic and etching techniques (step 2). A piezoelectric material is deposited on top of the thus formed ground electrode pattern 8 by sputtering over the entire panel (step 3).

Next, a piezoelectric pattern 7 is formed using photolithographic and etching techniques (step 4). In step 5, a chevron-shaped electrode 6 is formed by screen printing. Subsequently, a bus electrode is formed by screen printing (step 6).

The above step is followed by a dot spacer forming step (step 7). The dot spacers 5 are formed from silicone or the like, as described earlier, by using photolithographic and etching techniques. Finally, the thus fabricated panel substrate and the film or polarizer that covers the substrate are bonded together along the edges of the substrate by using a double-sided adhesive tape 3, to complete the fabrication of the touch panel 1.

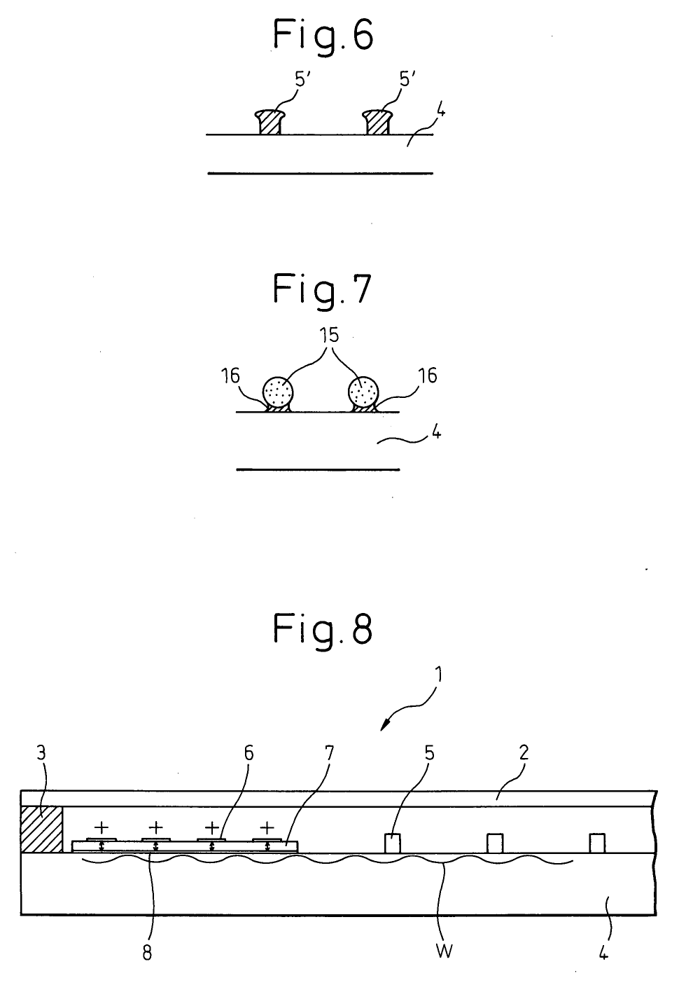

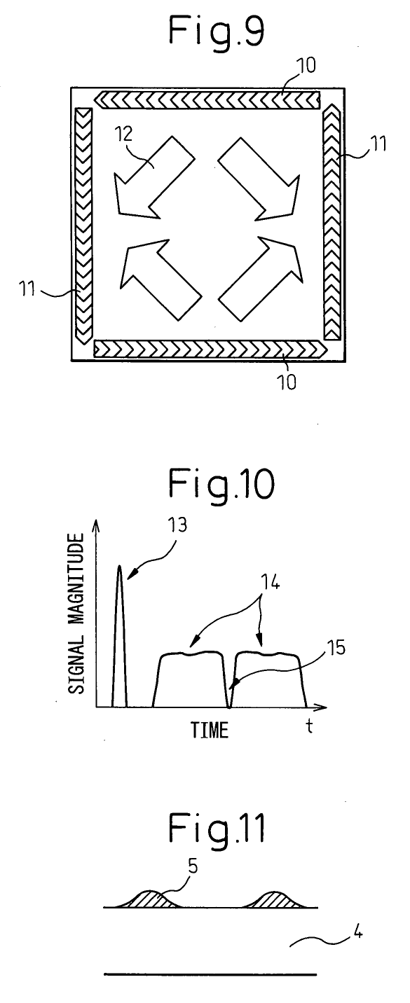

Overhanging spacers can also be formed by using a method similar to that described above. FIG. 6 shows such overhanging spacers. In the figure, reference numeral 4 indicates the glass substrate on which the overhanging dot spacers 5 are formed.

“Overhanging” refers to the spacer shape in which the cross-sectional area of the portion of the spacer contacting the glass is smaller than that of the upper portion thereof. To form spacers of such shape, in the present embodiment the exposure and development conditions were adjusted in the photolithographic process.

As described above, cylindrically shaped overhanging dot spacers that provide good propagation efficiency can be formed using the photolithographic process.

A second embodiment of the present invention concerns an example in which, instead of the above dot spacers, plastic beads each measuring 5 μn to 10 μm in diameter and having adhesive surfaces are dispersed over the surface of the SAW touch panel to form dot spacers using an adhesive.

FIG. 7 shows such dot spacers. Reference numeral 4 indicates the glass substrate on which the glass or plastic beads 5 are formed, and 16 indicates an adhesive. The dot spacers can thus be formed, which can maintain a prescribed spacing between the film and the glass.

When the spacer dispersion density in the panel was increased to 10 spacers or more per square millimeter, it was difficult to cause the film to touch the glass surface by pressing the film surface (operation surface) with a finger or the like, and a stronger pressing force (a higher input load) was required, thus greatly impairing the operability. Accordingly, to enhance the operability, it is preferable that the bead dispersion density be held within 10 beads per square millimeter.

A third embodiment of the present invention concerns a panel in which glass or plastic rods each measuring 5 μm to 10 μm in diameter and 30 μm or less in length are dispersed over the surface of the SAW touch panel (not shown).

It is preferable that the glass rod dispersion density be held within 5 rods per square millimeter.

As previously described, since the panel is basically constructed using a single glass substrate, the SAW touch panel has high transmittance, is less prone to color variations, provides clear visibility, and does not degrade the display quality of a liquid crystal display apparatus. The touch panel of the present invention is therefore expected to be used in combination with a liquid crystal display apparatus. The invention is particularly promising for such applications as compact mobile telephones, digital cameras, video cameras, car navigation systems, and small-sized game machines where a crisp screen and a touch panel function are demanded.

Although the above embodiments have been described as exemplary embodiments of the invention, it should be understood that additional modifications, substitutions, and changes may be made to the panel as disclosed herein. Accordingly, the scope of the present invention is by no means restricted by the specific embodiments described herein, but should be defined by the appended claims and their equivalents.

1. A surface acoustic wave type touch panel comprising:
a glass plate;
a film that faces a surface of said glass plate; and
dot spacers formed on said glass surface that faces said film, wherein
said dot spacers are each formed not larger in diameter than one half of the wavelength of a surface propagating acoustic wave.

2. A touch panel as claimed in claim 1, wherein said dot spacers are formed on said glass surface by using a photolithographic process.

3. A touch panel as claimed in claim 1, wherein said dot spacers are each formed in the shape of a polygonal or cylindrical column or in the shape of an overhanging polygonal or cylindrical column.

4. A touch panel as claimed in claim 1, wherein said dot spacers are formed by dispersing beads, each having a diameter not larger than one half of the wavelength of said surface propagating acoustic wave, or rods, each having a diameter or length not larger than one half of said wavelength, and by bonding said beads or rods to said glass plate.

5. A touch panel as claimed in claim 4, wherein said beads are dispersed at a density not higher than 10 beads per square millimeter.

6. A touch panel as claimed in claim 2, wherein said dot spacers are each formed in the shape of a polygonal or cylindrical column or in the shape of an overhanging polygonal or cylindrical column.
